(19) United States
(12) Patent Application Publication
(10) Pub. No.: US 2022/0232145 A1
(43) Pub. Date: Jul. 21, 2022

(54) METHOD FOR REAL TIME WHITEBOARD EXTRACTION WITH FULL FOREGROUND IDENTIFICATION

(71) Applicant: Konica Minolta Business Solutions U.S.A., Inc., San Mateo, CA (US)

(72) Inventor: Darrell Eugene Bellert, Boulder, CO (US)

(73) Assignee: Konica Minolta Business Solutions U.S.A., Inc., San Mateo, CA (US)

(21) Appl. No.: 17/154,631

(22) Filed: Jan. 21, 2021

(51) Int. Cl. H04N 5/14; G06T 7/66; G06T 7/136; G06T 7/194; G06T 7/187; H04N 7/04; G06T 7/11

(52) U.S. Cl. CPC H04N 5/147; G06T 7/66; G06T 7/136; G06T 2207/10016; G06T 7/187; H04N 7/04; G06T 7/11; G06T 7/194

(57) ABSTRACT

A method to extract static user content on a marker board is disclosed. The method includes generating a sequence of samples from a video stream comprising a series of images of the marker board, generating at least one center of mass (COM) of estimated foreground content of each sample in the sequence of samples, detecting, based on a predetermined criterion, a stabilized change of the at least one COM in the sequence of samples, wherein the stabilized change of the at least one COM identifies, in the sequence of samples, a stable sample with new content, generating, in response to the stabilized change of the at least one COM and from the stable sample with new content, a mask of full foreground content, and extracting, based at least on the mask of full foreground content, a portion of the static user content from the video stream.

### BACKGROUND

Whiteboards, also known as dry-erase boards, are different from blackboards in that whiteboards include a smoother writing surface that allows rapid marking and erasing of markings. Specifically, whiteboards usually include a glossy white surface for making nonpermanent markings, and are used in many offices, meeting rooms, school classrooms, and other work environments. Whiteboards may also be used to facilitate collaboration among multiple remote participants (referred to as collaborating users) that are sharing information. In such collaborations, one or more cameras are pointed at the whiteboard to share a user's written or drawn content with other participants.

### SUMMARY

In general, in one aspect, the invention relates to a method to extract static user content on a marker board. The method includes generating a sequence of samples from a video stream comprising a series of images of the marker board, generating at least one center of mass (COM) of estimated foreground content of each sample in the sequence of samples, detecting, based on a predetermined criterion, a stabilized change of the at least one COM in the sequence of samples, wherein the stabilized change of the at least one COM identifies, in the sequence of samples, a stable sample with new content, generating, in response to the stabilized change of the at least one COM and from the stable sample with new content, a mask of full foreground content, and extracting, based at least on the mask of full foreground content, a portion of the static user content from the video stream.

In general, in one aspect, the invention relates to a system for extracting static user content on a marker board. The system includes a memory and a computer processor connected to the memory and that generates a sequence of samples from a video stream comprising a series of images of the marker board, generates at least one center of mass (COM) of estimated foreground content of each sample in the sequence of sample, detects, based on a predetermined criterion, a stabilized change of the at least one COM in the sequence of samples, wherein the stabilized change of the at least one COM identifies in the sequence of samples a stable sample with new content, generates, in response to the stabilized change of the at least one COM and from the stable sample with new content, a mask of full foreground content, and extracts, based at least on the mask of full foreground content, a portion of the static user content from the video stream.

In general, in one aspect, the invention relates to a non-transitory computer readable medium (CRM) storing instructions for extracting static user content on a marker board. The computer readable program code, when executed by a computer, includes functionality for generating a sequence of samples from a video stream comprising a series of images of the marker board, generating at least one center of mass (COM) of estimated foreground content of each sample in the sequence of samples, detecting, based on a predetermined criterion, a stabilized change of the at least one COM in the sequence of samples, wherein the stabilized change of the at least one COM identifies in the sequence of samples a stable sample with new content, generating, in response to the stabilized change of the at least one COM and from the stable sample with new content, a mask of full foreground content, and extracting, based at least on the mask of full foreground content, a portion of the static user content from the video stream.

Other aspects of the invention will be apparent from the following description and the appended claims.

### BRIEF DESCRIPTION OF DRAWINGS

FIG. 1 shows a system in accordance with one or more embodiments of the invention.

FIG. 2 shows a flowchart in accordance with one or more embodiments of the invention.

FIGS. 3A-3O show an implementation example in accordance with one or more embodiments of the invention.

FIG. 4 shows a computing system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method, non-transitory computer readable medium, and system for extracting written content and/or user placed object(s) from a marker board using a live video stream or pre-recorded video where one or more users are interacting with the marker board. In a collaboration session between collaborating users, the extracted user content is sent to the collaborating user in real time while one or more users are writing/drawing/placing object(s) on the marker board. One or more embodiments of the invention minimize the amount of extraction updates sent to collaborating users by limiting the extraction updates to occur only when content changes in a specific region of the marker board.

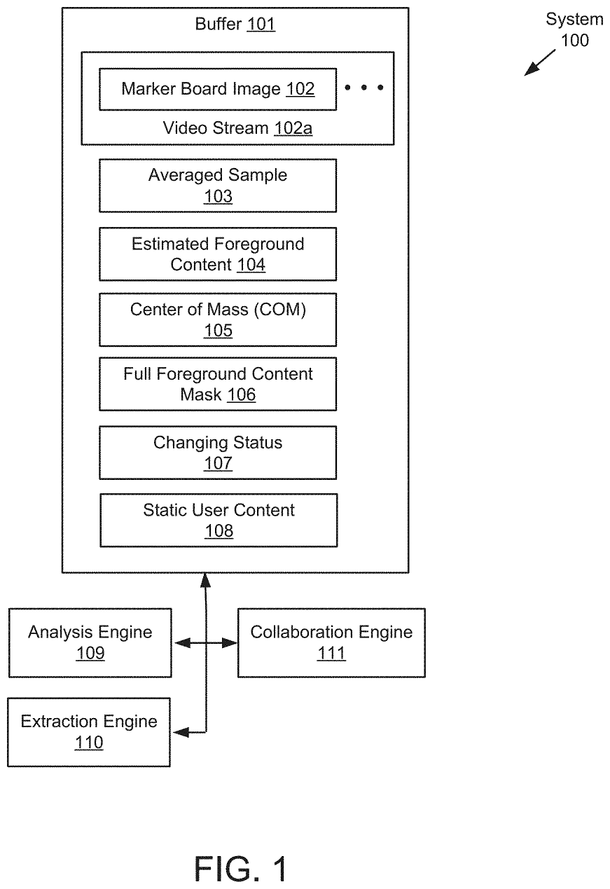

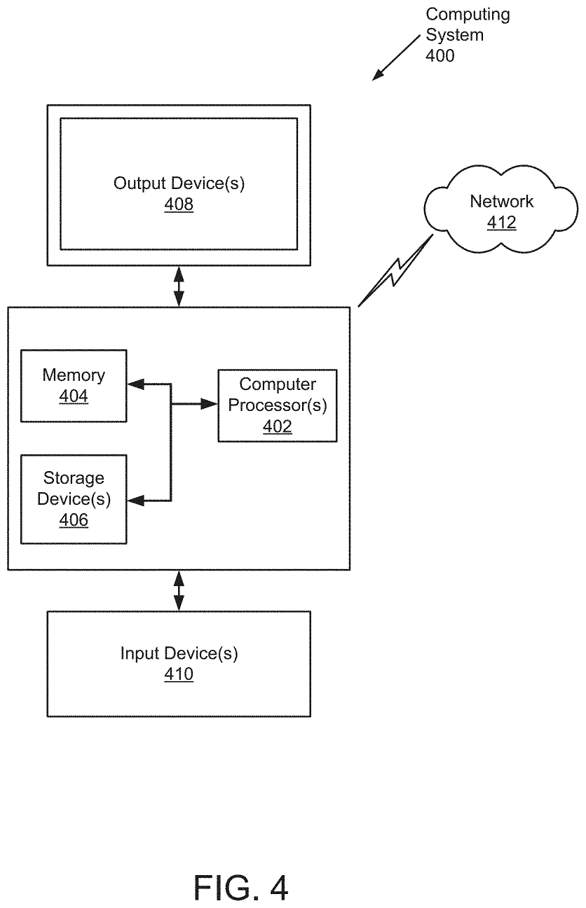

FIG. 1 shows a system (100) in accordance with one or more embodiments of the invention. As shown in FIG. 1, the system (100) has multiple components, including, for example, a buffer (101), an analysis engine (109), an extraction engine (110), and a collaboration engine (111). Each of these components (101, 109, 110, 111) may be implemented in hardware (i.e., circuitry), software, or any combination thereof. Further, each of these components (101, 109, 110, 111) may be located on the same computing device (e.g., personal computer (PC), laptop, tablet PC, smart phone, multifunction printer, kiosk, server, etc.) or on different computing devices connected by a network of any size having wired and/or wireless segments. In one or more embodiments, these components may be implemented using the computing system (400) described below in reference to FIG. 4. Each of these components is discussed below.

In one or more embodiments of the invention, the buffer (101) is configured to store a marker board image (102). The marker board image (102) is an image of a writing surface of a marker board captured using one or more camera devices (e.g., a video camera, a webcam, etc.). In particular, the marker board image (102) may be one image in a series of images in a video stream (102a) of the captured marker board, and may be of any size and in any image format (e.g., BMP, JPEG, TIFF, PNG, etc.).

The marker board is a whiteboard, blackboard, or other similar type of writing material. The writing surface is the surface of the marker board where a user writes, draws, or otherwise adds marks and/or notations. The user may also place physical objects on the writing surface. Throughout this disclosure, the terms “marker board” and “the writing surface of the marker board” may be used interchangeably depending on context.

The marker board image (102) may include content that is written and/or drawn on the writing surface by one or more users. Once written and/or drawn on the writing surface, the content stays unchanged until the content is removed (e.g., the content is erased by a user). In one or more embodiments, the written and/or drawn content is referred to as user written content. Additionally, the marker board image (102) may include content corresponding to object(s) placed on the marker board, a user's motion in front of the marker board, and/or sensor noise generated by the camera device. The user's written content and content resulting from user placed object(s), and user's motion, and/or sensor noise collectively form a foreground content of the marker board image (102). The user's written content and content resulting from the user placed object(s) are collectively referred to as static user content of the marker board image (102).

In one or more embodiments, the buffer (101) is further configured to store the intermediate and final results of the system (100) that are directly or indirectly derived from the marker board image (102) and the video stream (102a). The intermediate and final results include at least an averaged sample (103), an estimated foreground content (104), a center of mass (COM) (105), a full foreground content mask (106), a changing status (107), and the static user content (108). Each of these intermediate and final results is described below in detail.

In one or more embodiments, the averaged sample (103) is an average of a contiguous portion of the video stream (102a), where the contiguous portion corresponds to a short time period (e.g., 0.25 seconds) during the collaboration session. The averaged sample (103) is one averaged sample within a sequence of averaged samples. Each pixel of the averaged sample (103) is assigned an averaged pixel value of corresponding pixels in all images within the contiguous portion of the video stream (102a). For example, the marker board image (102) may be one of the images in the contiguous portion of the video stream (102a).

Furthermore, the averaged sample (103) includes multiple divided regions of the marker board. Each region is referred to as a tile and may be represented as a rectangle, square, or any other planar shape. In this disclosure, the term “tile” is also used to refer to an image of the tile.

In one or more embodiments, the estimated foreground content (104) is a binary mask generated using the averaged sample (103). Each pixel of the estimated foreground content (104) is assigned a binary value that estimates the pixel as either the foreground pixel or the background pixel of the averaged sample (103). In one or more embodiments, the estimated foreground content (104) is generated by applying an adaptive thresholding algorithm to the averaged sample (103). Due to the adaptive thresholding algorithm, the edges or outlines of foreground objects are emphasized in the estimated foreground content (104) and the interior region of the foreground objects are de-emphasized in the estimated foreground content (104). As will be described below, the estimated foreground content (104) is used to detect changes in the foreground content of the marker board image (102) and when the changes become stabilized. Therefore, de-emphasizing the interior region of the foreground objects in the estimated foreground content (104) advantageously does not cause any adverse effects to occur on the overall processing.

In one or more embodiments, the COM (105) is a pixel location in a tile where the coordinates are averaged from all estimated foreground pixels in the estimated foreground (104). As the user writes/draws or places object(s) into a particular tile, the COM (105) changes due to the user's hand motion and/or due to the added static user content (108).

In one or more embodiments, the full foreground content mask (106) is a binary mask where each pixel is assigned a binary value that designates the pixel as either the foreground pixel or the background pixel of the averaged sample (103).

In one or more embodiments, the changing status (107) is a status of an averaged sample (103) indicating whether a significant change in the COM (105) has stabilized over a stability window, which is a predetermined number (e.g., 2, 10, etc.) of subsequent averaged samples (103). A significant change in the COM (105) that has stabilized over the stability window is referred to as a stabilized change. In one or more embodiments, the changing status (107) includes STABLE, CHANGING, STABILIZING, and STABLE WITH NEW CONTENT. STABLE indicates that there are no significant changes in the COM (105) from one averaged sample (103) to the subsequent averaged sample (103). CHANGING indicates that there is a significant change in the COM (105) from one averaged sample (103) to the subsequent averaged sample (103). STABILIZING occurs after a CHANGING state so long as the COM (105) no longer significantly changes over the stability window. If at the end of the stability window the COM has significantly moved from its location prior to entering the CHANGING state, then it is deemed STABLE_WITH_NEW_CONTENT otherwise returns back to STABLE. A STABLE_WITH_NEW_CONTENT state indicates that there is new user content that should be shared with remote participants.

In one or more embodiments of the invention, the analysis engine (109) is configured to generate a sequence of averaged samples (including the averaged sample (103)) and corresponding estimated foreground content (including the estimated foreground content (104)) from the video stream (102a). The analysis engine (109) is further configured to generate the COM (105) for each tile of the samples.

In one or more embodiments of the invention, the extraction engine (110) is configured to detect a stabilized change of the COM (105) in the sequence of samples, to generate the full foreground content mask (106), and to extract the static user content (108) in a corresponding tile of the video stream (102a) where the stabilized change is detected. As the user writes/draws and/or places object(s) across the entire writing surface of the marker board, the static user content (108) in the extracted tile of the video stream (102a) represents only a portion of the entire static user content (108) across the marker board.

In one or more embodiments of the invention, the collaboration engine (111) is configured to generate the static user content (108) by aggregating all portions of the static user content (108) in all of the tiles of the video stream. The collaboration engine (111) is further configured to send an entirety or a portion of the static user content (108) to one or more collaborating users. The act of sending only a portion or the entirety of the static user content (108) to collaborating user(s) is referred to as an extraction update of the collaboration session.

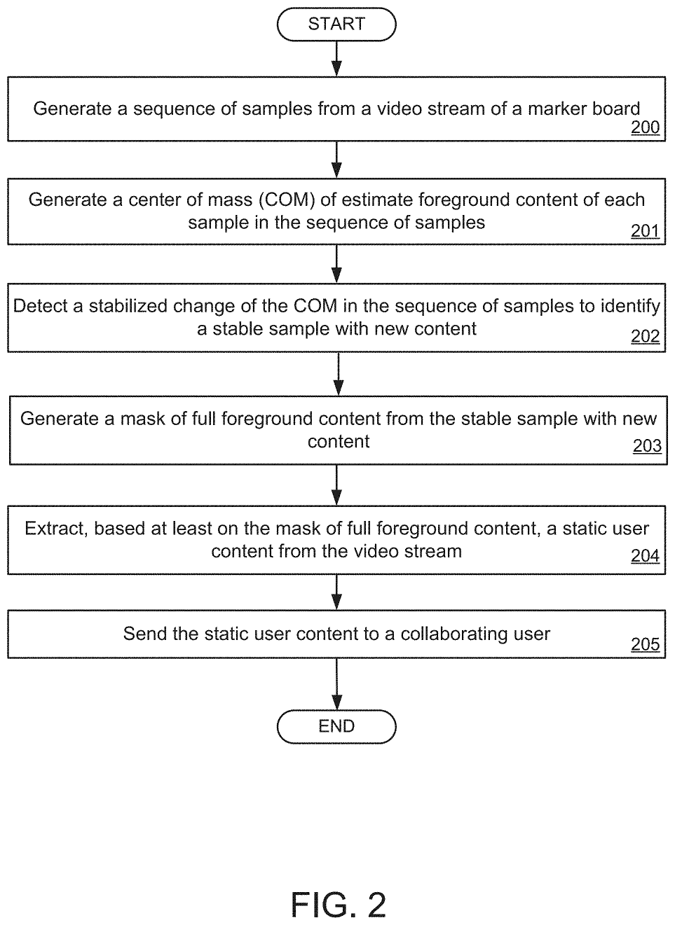

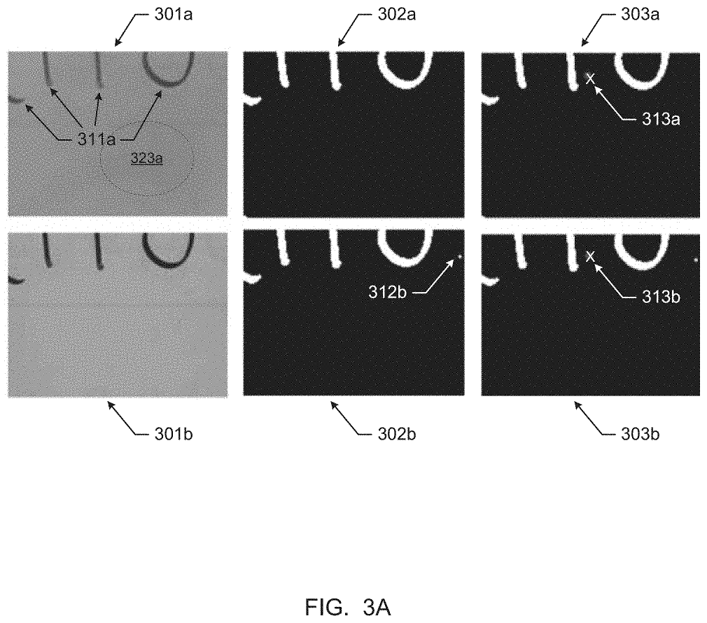

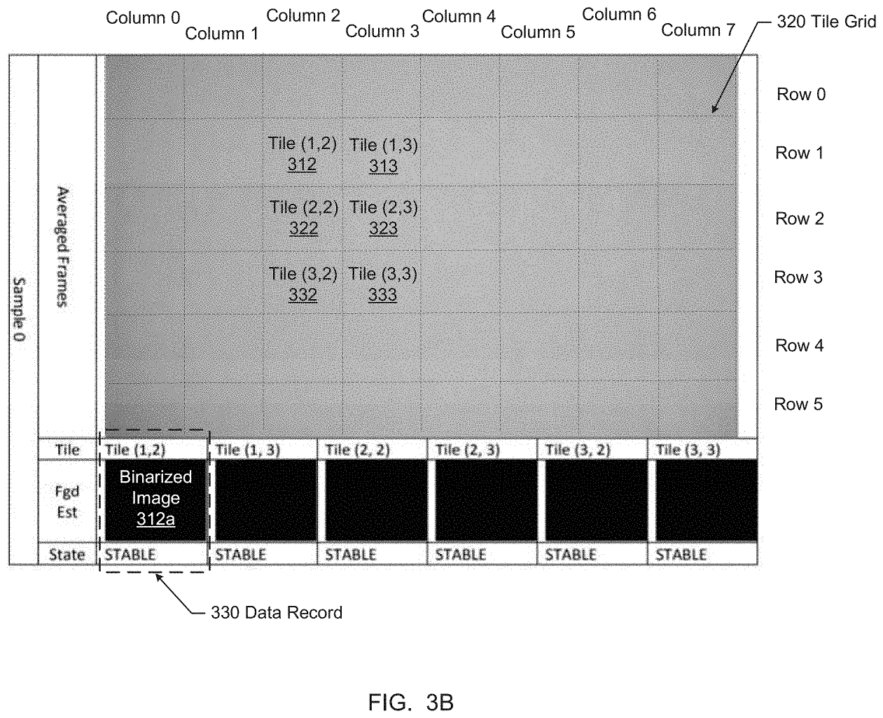

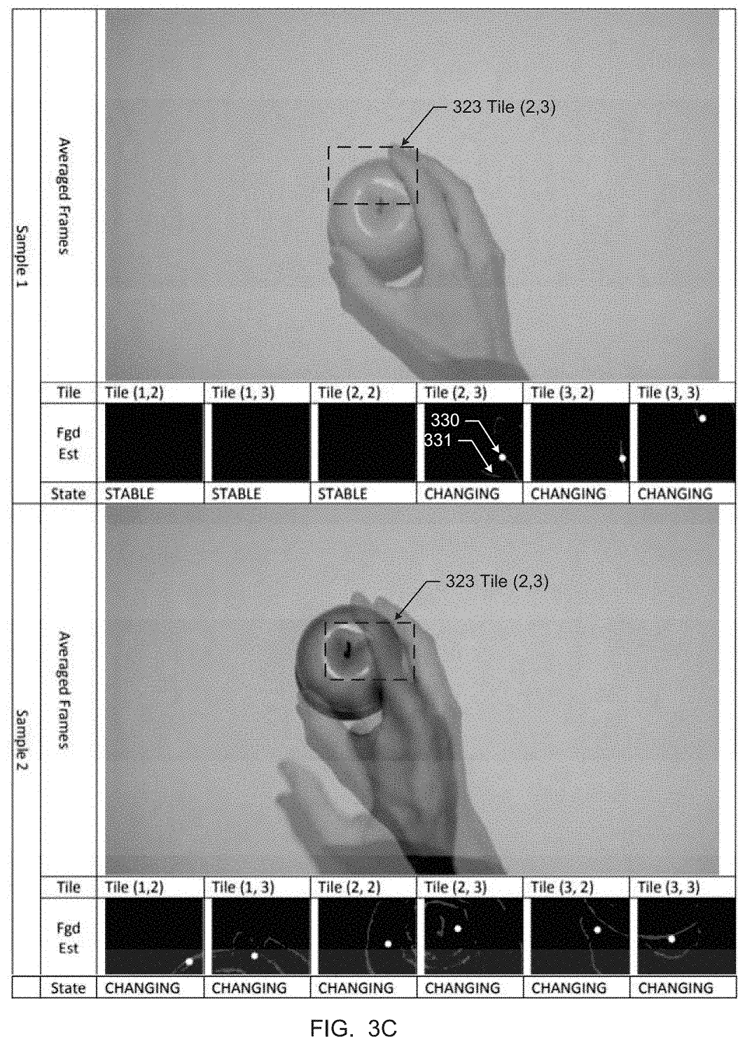

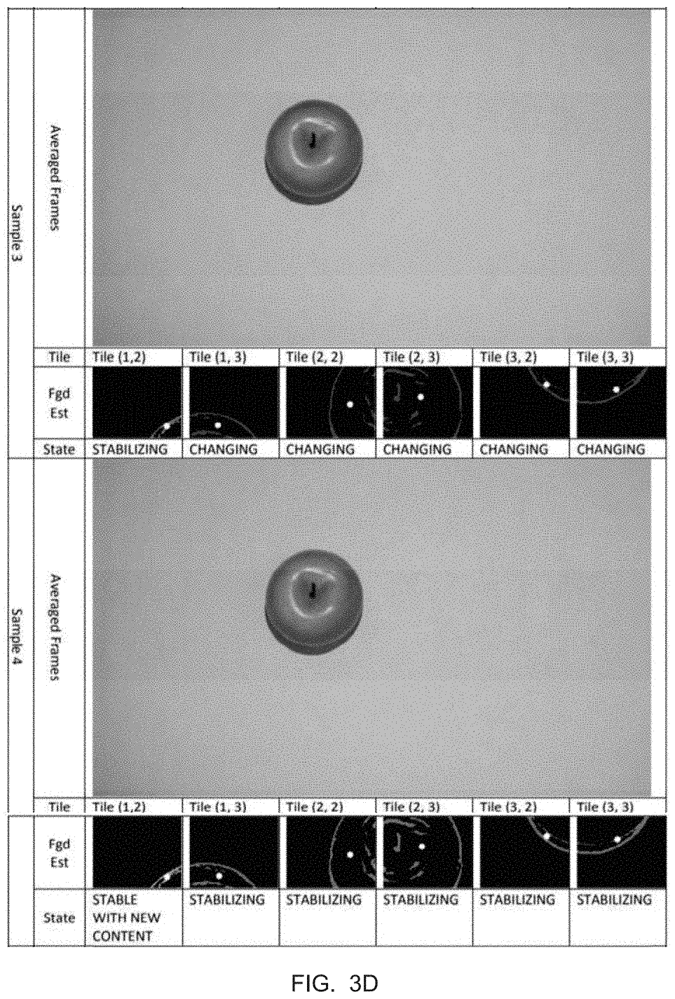

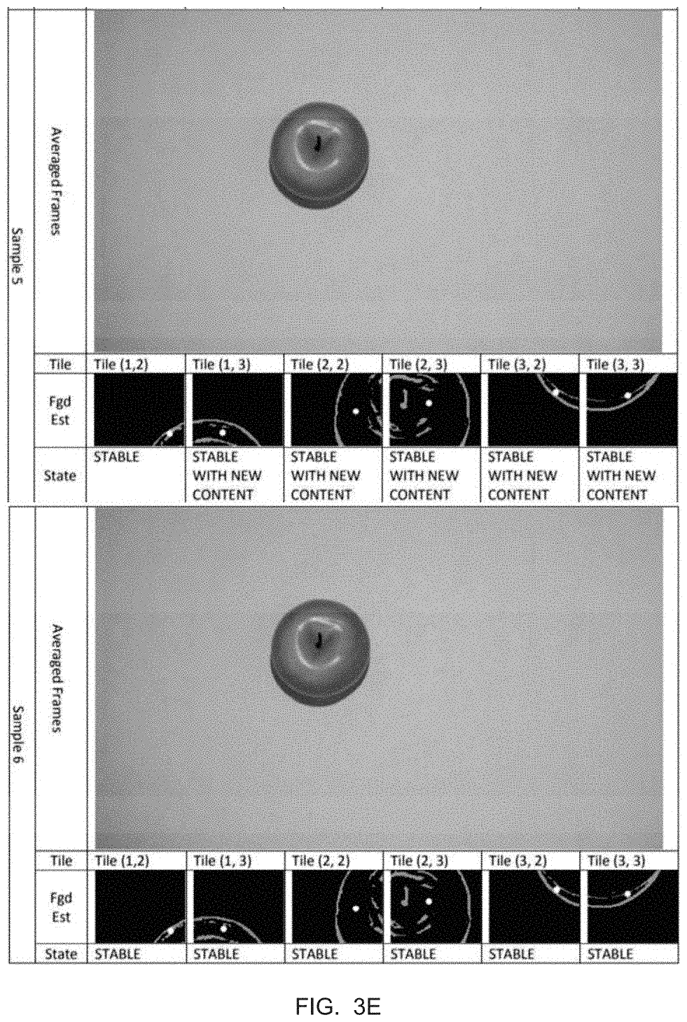

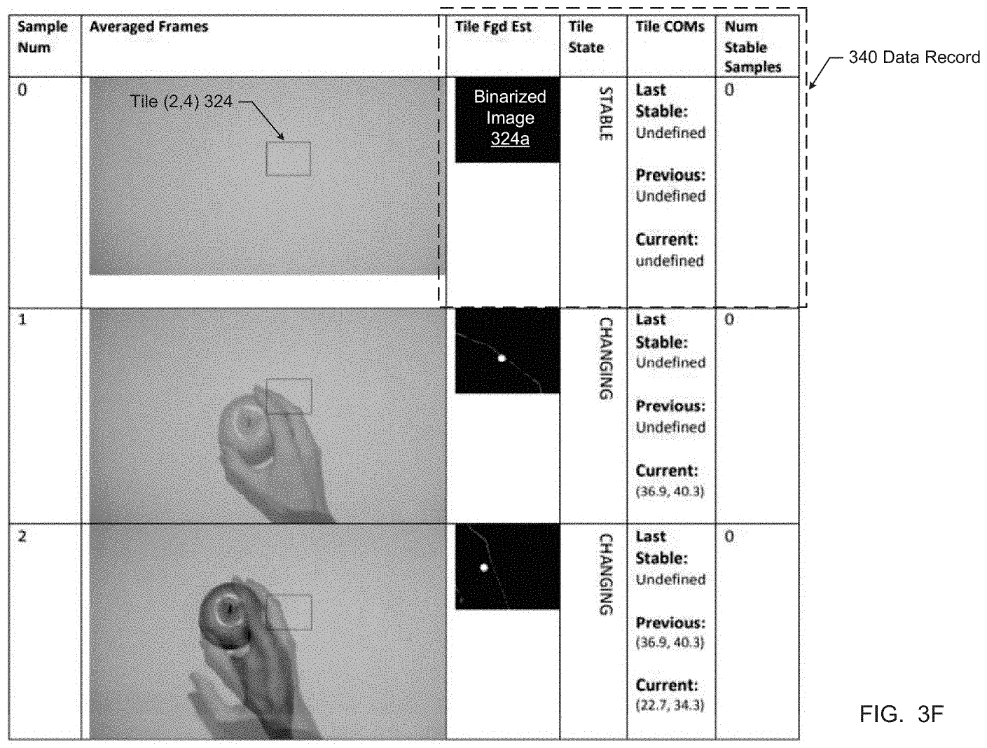

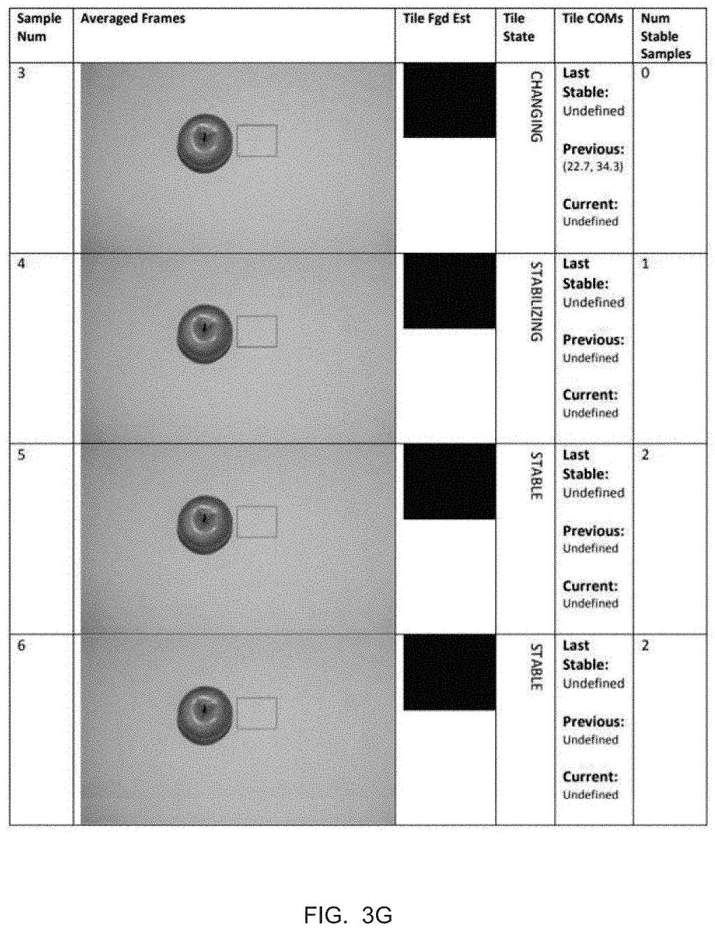

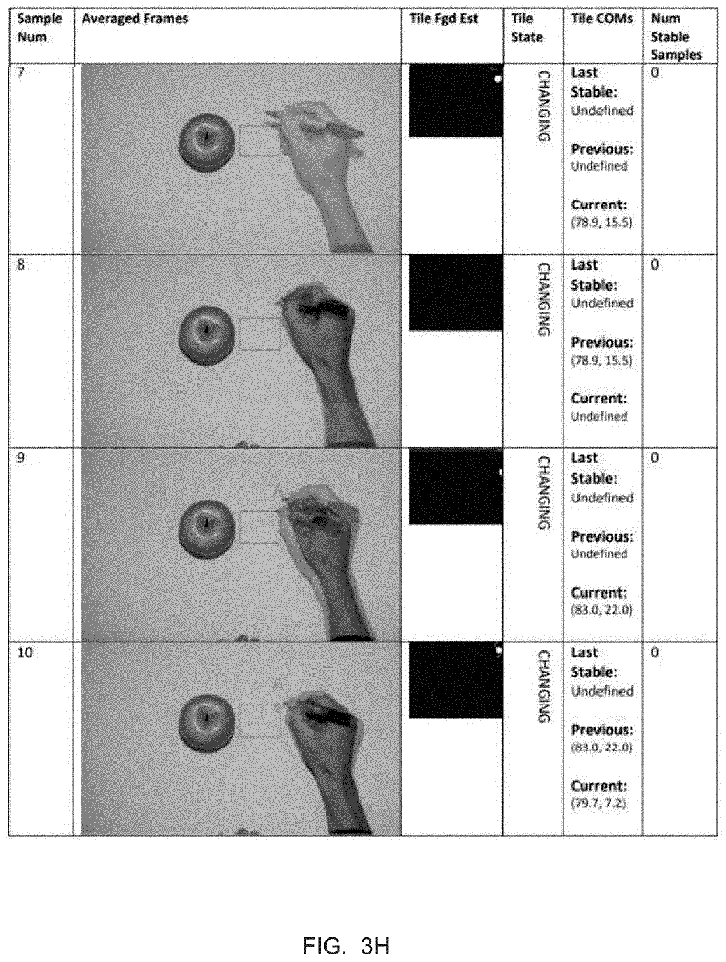

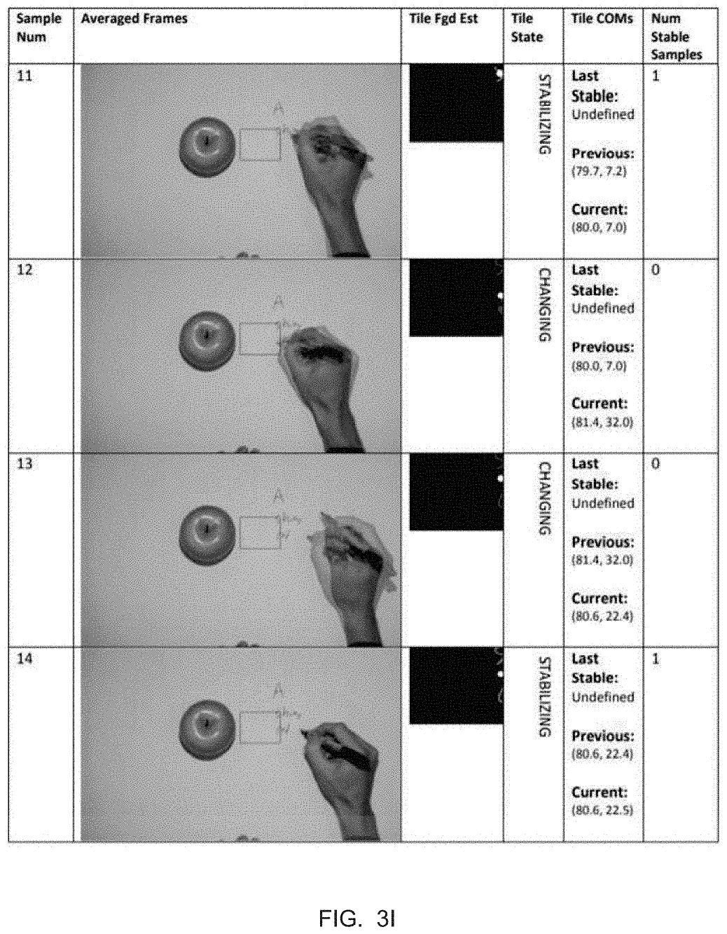

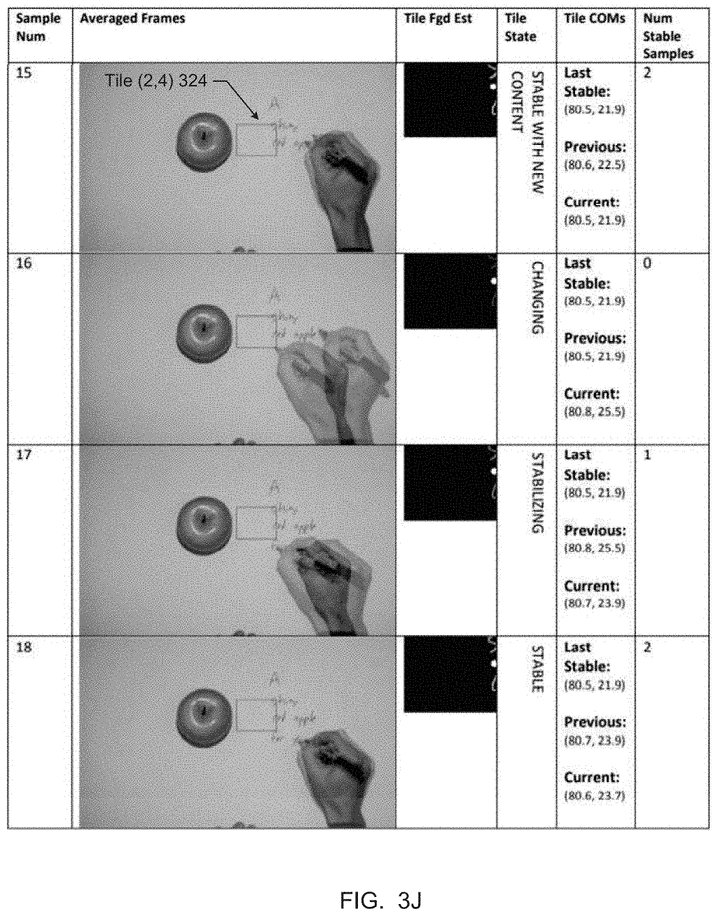

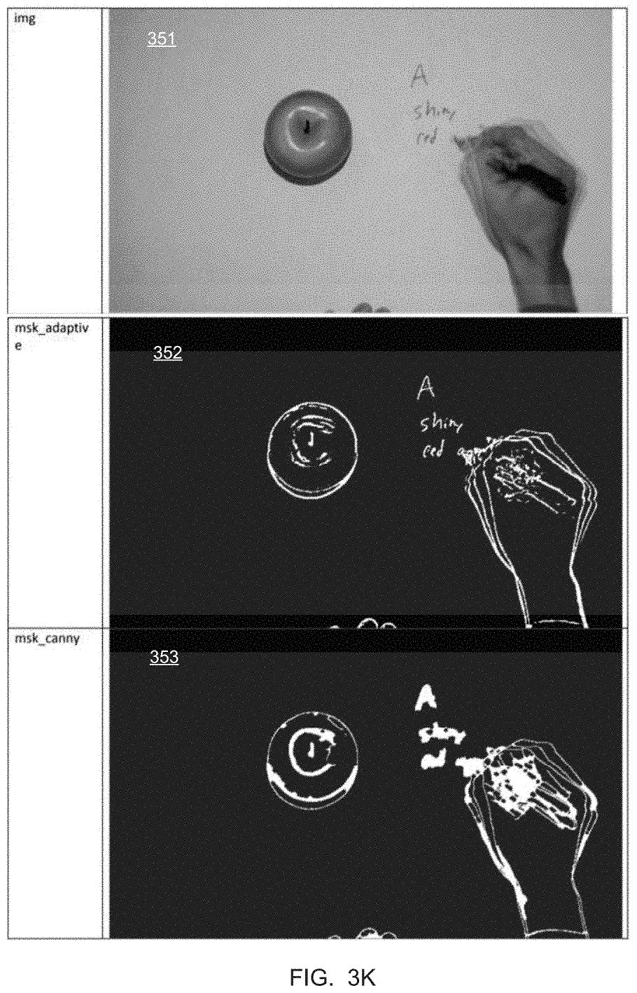

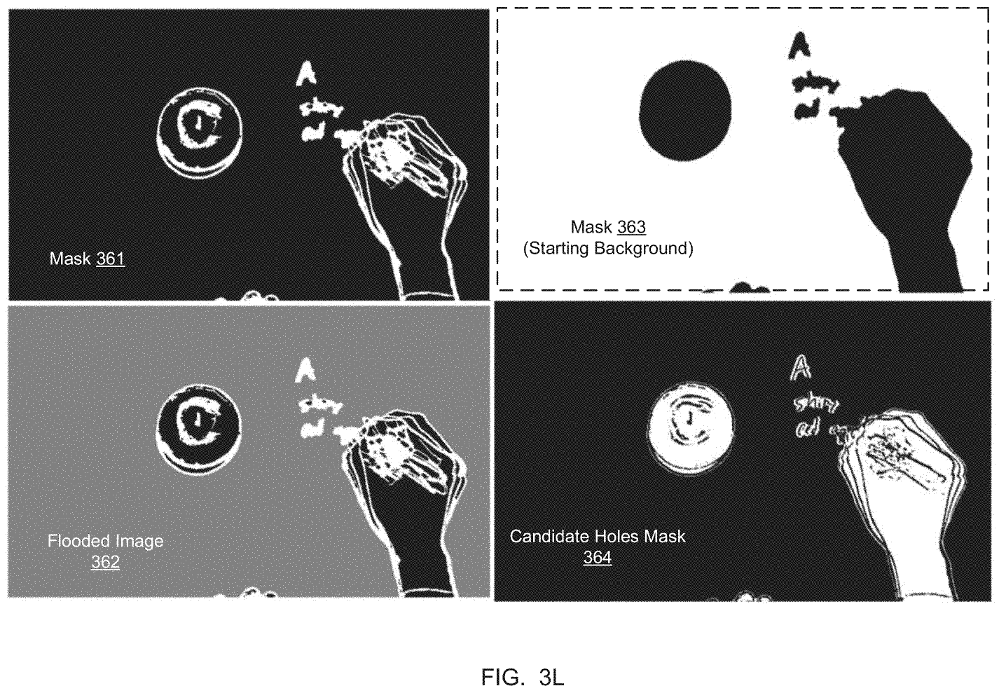

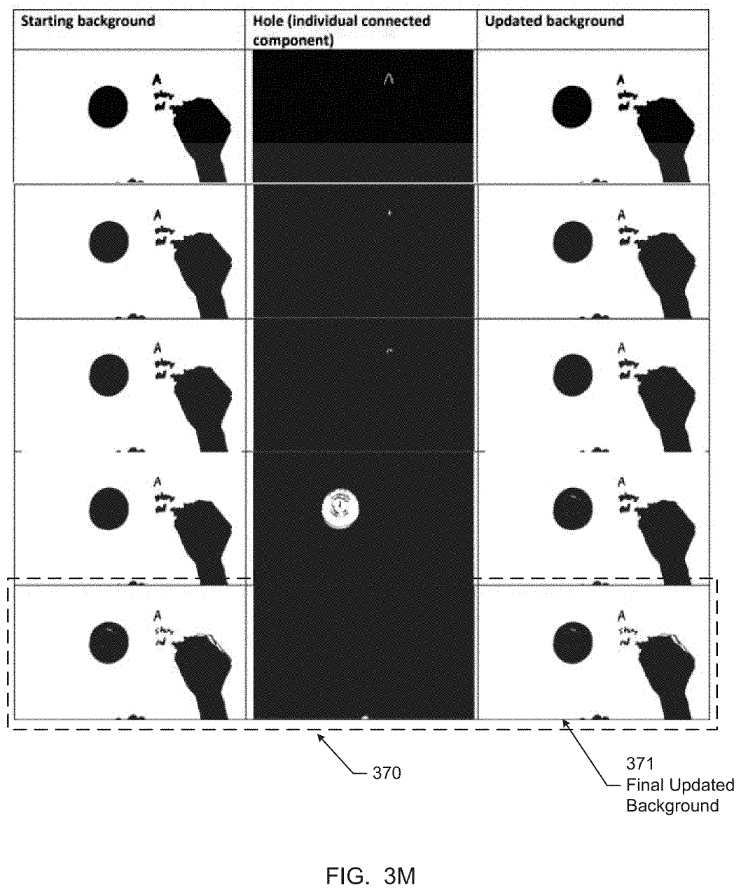

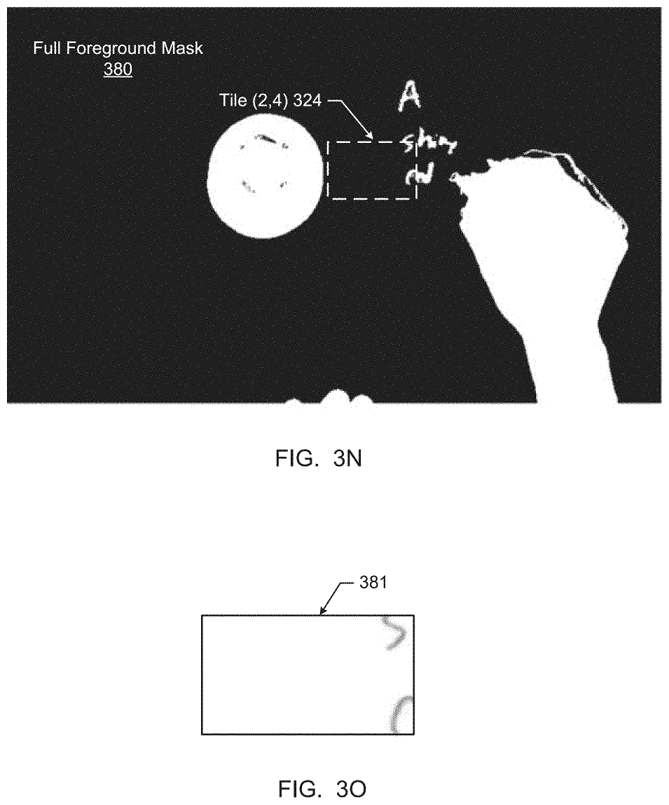

In one or more embodiments, the analysis engine (109), the extraction engine (110), and the collaboration engine (111) perform the functions described above using the method described in reference to FIG. 2 and the algorithms listed in TABLES 1-5 below. An example of automatically extracting static user content (108) from a video stream of the marker board is described in reference to FIGS. 3A-3O below.

Although the system (100) is shown as having four components (101, 109, 110, 111), in one or more embodiments of the invention, the system (100) may have more or fewer components. Furthermore, the functions of each component described above may be split across components. Further still, each component (101, 109, 110, 111) may be utilized multiple times to carry out an iterative operation.

FIG. 2 shows a flowchart in accordance with one or more embodiments of the invention. One or more of the steps in FIG. 2 may be performed by the components of the system (100), discussed above in reference to FIG. 1. In one or more embodiments, one or more of the steps shown in FIG. 2 may be omitted, repeated, and/or performed in a different order than the order shown in FIG. 2. Accordingly, the scope of the invention should not be considered limited to the specific arrangement of steps shown in FIG. 2.

Referring to FIG. 2 and as discussed above in reference to FIG. 1, initially in Step 200, a sequence of samples is generated from a video stream. The video stream is obtained from a camera oriented toward a marker board and includes a series of images of the marker board. In an example configuration of one or more embodiments, the optical axis of the camera is perpendicular to the writing surface of the marker board with the field of view aligned with the edges of the writing surface. Based on such configuration, every single pixel in each image in the video stream has a one-to-one correspondence with a specific location on the writing surface. Alternatively, in an example configuration with a different camera orientation and different field of view coverage, software corrections may be applied to each image of the video stream to correct any perspective distortions and/or to crop the images to match the writing surface with each pixel of the image.

In one or more embodiments, the series of images is divided into consecutive portions where each portion is contiguous and includes consecutive images in the video stream. In one example, the consecutive portions may all have the same number of consecutive images. In another example, the number of consecutive images may vary from one portion to another. Regardless of whether the number of consecutive images is constant or variable, the consecutive images in each portion are averaged to generate a corresponding sample. In one or more embodiments, each sample is scaled down in pixel resolution to improve processing performance in the subsequent steps. Each sample is converted into a binarized sample using an adaptive thresholding algorithm where the two binary pixel values are used to identify an estimated foreground content of the sample. For example, each ON pixel (i.e., a pixel having a pixel value of “1”) in the estimated foreground content represents a portion of the foreground content of the sample. Using the adaptive thresholding algorithm, the edges or outlines of foreground objects are emphasized in the estimated foreground content and the interior region of the foreground objects are de-emphasized in the estimated foreground content. As will be described below, the estimated foreground content is used to detect changes in the foreground content and to detect when the changes have stabilized. Therefore, de-emphasizing the interior region of the foreground objects advantageously does not cause any adverse effect to occur on the overall processing.

In one or more embodiments, the image frame in the video stream is divided into a number of tiles. In one example, the image frame may be divided equally into rectangular shaped (or other planar shaped) tiles. Each tile in the image frame corresponds to a rectangular section of the marker board, and each rectangular section of the marker board is referred to as a tile of the marker board. In another example, the tiles may have different form factors within the image frame and across the marker board where a dimension of a tile is at least twice the width of writing/drawing strokes in the image.

In Step 201, as discussed above in reference to FIG. 1, at least one center of mass (COM) of the estimated foreground content in each sample is generated. In one or more embodiments, the COM is generated for each tile of the sample being processed. The COM is a location in the tile of the sample where the X coordinate is equal to the average of X coordinates of all foreground pixels in the tile portion of the estimated foreground content and where the Y coordinate is equal to the average of Y coordinates of all foreground pixels in the tile portion of the estimated foreground content.

In Step 202, as discussed above in reference to FIG. 1, a stabilized change of the at least one COM is detected in the sequence of samples. In one or more embodiments, the COMs in a tile of each sample and that of a preceding sample are compared against one another to detect a shift in COM of a tile that exceeds a predetermined threshold. The shift in COM exceeding the predetermined threshold is referred to as a significant change of the COM. A significant change of the COM followed by at least a predetermined number of stable samples is identified as the stabilized change of the COM. The stable samples are identified as the stable sample with new content. In one or more embodiments, a stabilized change of the COM is detected for each tile and the process may be performed using parallel computing techniques. For each tile, generating the COM and monitoring the change in the COM from sample to sample may be performed by a parallel computing thread.

In Step 203, as discussed above in reference to FIG. 1, a mask of full foreground content is generated, in response to the stabilized change of the COM, from the stable sample with new content. An edges mask is first obtained (e.g. using Canny edge detection) of the entire sample. A flood fill algorithm is applied to the union of the estimated foreground content and the edges mask to generate a starting background. In the starting background, pixels exterior to the foreground object edges become flooded pixels that identify known background. To identify any holes in the foreground object that are missing in the starting background, a bitwise-and operation is applied to an inversion of the starting background and an inversion of the estimated foreground content to generate a candidate holes mask. The candidate holes mask includes potential holes in the foreground objects. Accordingly, one or more connected components in the candidate holes mask are identified as hole(s) and used to iteratively adjust the starting background to generate an ending background. A connected component in the candidate holes mask is identified as a hole in a foreground object based on comparing pixel intensities of the connected component pixels to an average pixel intensity of neighboring pixels of the known background. The ending background is then inverted to generate the mask of the full foreground content. In contrast to Step 202 where the stabilized change of COM is detected on a per-tile basis, the mask of full foreground content is generated all at once for all of the tiles.

In Step 204, as discussed above in reference to FIG. 1, the static user content is extracted, in response to the stabilized change of the COM, from the video stream using the mask of full foreground content. In one or more embodiments, a bitwise-and operation is applied to the sample and the mask of full foreground content where the stabilized change of the COM is detected. In the embodiments where the image frame is divided into tiles, the full foreground content of each tile is aggregated over all tiles to generate the full foreground content for the entire image frame.

In Step 205, as discussed above in reference to FIG. 1, the static user content is sent to a collaborating user. In an example scenario, the video stream is a live video stream of a collaboration session wherein the static user content is sent to the collaborating user in real-time with respect to the live video stream. In other words, the static user content is sent within a relatively short time (e.g., less than 0.5 seconds) after the content is written/drawn on the marker board.

An example of the method flowchart is described in TABLEs 1-5 and FIGS. 3A-3O below. An example main algorithm for performing Steps 200 to 205 above is listed in TABLE 1 below.

TABLE 1

| 1. | An empty list of recent_records is built. The recent_records list | |
|---|---|---|
| | records a set of recently processed data, whereby each record | |
| | specifically records: | |
| | 1.1. | The sample_num, which is a sequential counter of |
| | | samples. One or more frames in the video stream are |
| | | averaged together into a single sample. |
| | | Processing occurs on a sample-by-sample basis. |
| | 1.2. | The sample_orig, which is an image and records the |
| | | result of individual frames being averaged together. |
| | 1.3. | The sample_down, which is a scaled down version of |
| | | sample_orig. |
| | 1.4. | The msk_adaptive, which is a mask and records the |
| | | results of running an adaptive thresholding operation on |
| | | sample_down. |
| | 1.5. | The msk_canny, which is a mask and records the results |
| | | of running an edge detection operation on sample_down. |
| 2. | Initialize two images, update_img and update_fg to empty | |
| | images with dimensions equal to the dimensions of the frames | |
| | in the video stream. These images record the current state of | |
| | stable image content and identified foreground, respectively. | |
| 3. | Identify a scale_factor, which is used to downscale the frames | |
| | if they are too large. This can be set by the user or determined | |
| | automatically based on hardware characteristics and the | |
| | dimensions of the frames in the video stream. Some processing | |
| | occurs on the scaled down version of input | |
| | as a performance optimization. | |
| 4. | Generate a tile_grid by dividing up the area of a frame into a | |
| | collection of tiles. For each tile in the tile_grid, record the | |
| | following information in a TileMonitor structure: | |
| | 4.1. | The row this tile belongs to. |
| | 4.2. | The col this tile belongs to. |
| | 4.3. | The rectangular roi_orig that records the area of |
| | | sample_orig that this tile corresponds to. |
| | 4.4. | The rectangular roi_down that records the area of |
| | | sample_down that this tile corresponds to. |
| | 4.5. | The current state of the tile, which can be one of STABLE, |
| | | CHANGING, STABILIZING, or STABLE_WITH_ |
| | | NEW_CONTENT, initialized to STABLE. |
| | 4.6. | A count n_stable_samples that records across how many |
| | | samples the tile has been stabilizing, initialized to 0. |
| | 4.7. | A cur_center_of_mass that records the current center of |
| | | foreground content, initialized to undefined. |
| | 4.8. | A prey_center_of_mass that records the most recent center |
| | | of foreground content, initialized to undefined. |
| | 4.9. | A last_stable_center_of_mass that records the most recent |
| | | center of foreground content that was deemed |
| | | stable, initialized to undefined. |

The following main process is then repeated for each frame of the stream as detailed by way of example in TABLE 2.

TABLE 2

| 1. | A frame_step is computed as the current frame number modulo the | | | | | |
|---|---|---|---|---|---|---|
| | number of frames_per_sample, which is a parameter that | | | | | |
| | identifies how many tile frames are | | | | | |
| | averaged together into a single sample. | | | | | |
| 2. | If frame_step is zero, then this is the first frame in a sample set and | | | | | |
| | so perform the following steps: | | | | | |
| | 2.1. | If the size of the recent records array is equal to n_ | | | | |
| | | samples_stability_window, which is a parameter that | | | | |
| | | defines how many samples must be classified as stable | | | | |
| | | before an update can be sent, then remove | | | | |
| | | the oldest record in recent_records. | | | | |
| | 2.2. | Create an empty record and add it to recent_records. | | | | |
| | 2.3. | Initialize sample_orig in the most recently added | | | | |
| | | record to an empty image with dimensions equal | | | | |
| | | to the dimensions of the frames in the video stream. | | | | |
| 3. | Identify the most recently added record in recent_records as cur_rec. | | | | | |
| 4. | Add in the current frame to cur_rec.somple_orig. | | | | | |
| 5. | If frame_step is equal to one less than frames_per_sample, then we | | | | | |
| | have arrived at a sample boundary and the following steps are | | | | | |
| | performed: | | | | | |
| | 5.1. | cur_rec.sample_num is recorded as the frame number | | | | |
| | | integer divided by frames_per_sample. | | | | |
| | 5.2. | Generate a true average by dividing cur_rec.sample_orig by frames_per_sample. | | | | |
| | 5.3. | Scale down cur_rec.sample_orig by scale_factor, placing the result in | | | | |
| | | cur_rec.sample_down. | | | | |
| | 5.4. | Threshold cur_rec.sample_down to make a mask cur_rec.msk_adaptive to provide an | | | | |
| | | estimate of foreground content in contrast with the whiteboard background. Although | | | | |
| | | there are several ways to do this, it has been experimentally determined that an ideal | | | | |
| | | way is to use an adaptive thresholding function on each color channel and then | | | | |
| | | combine each channel together using a bitwise OR operation. More specifically: | | | | |
| | | 5.4.1. | Initialize cur_rec.msk_adaptive to an empty image. | | | |
| | | 5.4.2. | Repeat for each channel in cur_rec.sample_down: | | | |
| | | | 5.4.2.1. | Execute the OpenCV adaptivethreshold function on the channel | | |
| | | | 5.4.2.2. | Bitwise-or the results of adaptivethreshold into cur_rec.msk_adaptive. | | |
| | | 5.4.3. | Clear out holes in and slightly expand the size of cur_rec.msk_adaptive using | | | |
| | | | morphological operations. This will help identify areas of strokes where the | | | |
| | | | whiteboard marker may have faded and consequentially were not initially | | | |
| | | | identified in cur_rec.msk_adaptive as well as reduce flickering from sample to | | | |
| | | | sample. One way to accomplish this is with OpenCV functions: | | | |
| | | | 5.4.3.1. | Obtain a morphological structuring element of a pre-configured size using | | |
| | | | | OpenCV's getStructuringElement. | | |
| | | | 5.4.3.2. | Dilate cur_rec.msk_adaptive using OpenCV's dilate | | |
| | 5.5. | Spatially monitor the foreground for static content. Start by initializing any_updates | | | | |
| | | to false and then for each tile in the tile_grid do: | | | | |
| | | 5.5.1. | Call a function monitor_tile( ), explained below, with parameters | | | |
| | | | cur_rec.sample_nun and cur_rec.msk_adaptive (which is the mask of estimated | | | |
| | | | foreground content) that returns the current state of the tile. | | | |
| | | 5.5.2. | If the returned state is STABLE_WITH_NEW_CONTENT, | | | |
| | | | then set any_updates to true. | | | |
| | 5.6. | If any_updates is true, then a tile has new content to share based on the foreground | | | | |
| | | estimate. | | | | |
| | | 5.6.1. | Now generate the full foreground: | | | |
| | | | 5.6.1.1. | Average all sample_orig images across all records in recent_records to | | |
| | | | | avg_sample_orig. | | |
| | | | 5.6.1.2. | Average all sample_down images across all records in recent_records to | | |
| | | | | avg_sample_down. | | |
| | | | 5.6.1.3. | Average all msk_adaptive masks across all records in recent_records to | | |
| | | | | avg_msk at. | | |
| | | | 5.6.1.4. | For every record in recent_records, generate msk_canny if it is missing: | | |
| | | | | 5.6.1.4.1. | Initialize cur_rec.msk_canny to an empty image. | |
| | | | | 5.6.1.4.2. | Repeat for each channel in cur_rec.sample_down: | |
| | | | | | 5.6.1.4.2.1. | Execute the OpenCV canny_edge function on the |
| | | | | | | channel |
| | | | | | 5.6.1.4.2.2. | Bitwise-or the results of canny_edge into |
| | | | | | | cur_rec.msk_canny. |
| | | | | 5.6.1.4.3. | Clear out holes in cur_rec.msk_adaptive using morphological | |
| | | | | | operations. One way to accomplish this is with OpenCV functions: | |
| | | | | | 5.6.1.4.3.1. | Obtain a morphological structuring element of a pre- |
| | | | | | | configured size using OpenCV's getStructuringElement. |
| | | | | | 5.6.1.4.3.2. | Dilate cur_rec.msk_canny using OpenCV's dilate |
| | | | | | 5.6.1.4.3.3. | Erode cur_rec.msk_canny using OpenCV's erode |

| | 5.6.1.5. | Average all msk_canny masks across all records in recent_records to | |
|---|---|---|---|
| | | avg_msk_cn. | |
| | 5.6.1.6. | avg_msk_at is an average of recent adaptive threshold masks. Threshold | |
| | | that to find the majority of pixels that are on using OpenCV's threshold | |
| | | operation. | |
| | 5.6.1.7. | avg_msk_cn is an average of recent canny edge masks. Threshold that to | |
| | | find the majority of pixels that are on using OpenCV's threshold operation. | |
| | 5.6.1.8. | Call the function IdentifyForeground( ), detailed below, with parameters | |
| | | avg_sample_down, avg_msk_at, and avg_msk_cn which returns the | |
| | | identified foreground based on avg_sample down. | |
| | 5.6.1.9. | Generate the full foreground by scaling the returned identified | |
| | | foreground up to the dimensions of avg_sample_orig. | |
| 5.6.2. | Repeat for all tiles in tile_grid: | | |
| | 5.6.2.1. | If the tile's state is either STABLE or STABLE_WITH_NEW_CONTENT, | |
| | | then: | |
| | | 5.6.2.1.1. | Copy the tile's portion of the full foreground to update_fg. |
| | | 5.6.2.1.2. | Copy the tile's portion of avg_sample_orig bitwise-anded with the |
| | | | tile's portion of the full foreground to update_img, adding in the |
| | | | foreground as an alpha channel. |

| | |
|---|---|
| 5.6.3. | Share update_img among collaborators. |

The function monitor_tile(sample_num, foreground) can be expanded, for example, as detailed in TABLE 3.

TABLE 3

| 1. | If the state is currently STABLE_WITH_NEW_CONTENT, set the state to STABLE. | | | | | | | |
|---|---|---|---|---|---|---|---|---|
| 2. | Identify the sub-region offoreground that overlaps with roi_down as tile. | | | | | | | |
| 3. | Identify cur_center_of_mass as the average position of all foreground pixels in tile. | | | | | | | |
| 4. | Read the tile's current state. | | | | | | | |
| | 4.1. | If the tile's state is STABLE, then: | | | | | | |
| | | 4.1.1. | See if the tile is no longer stable. Set res to the result of calling the function | | | | | |
| | | | significant_change( ), detailed below, with the parameters | | | | | |
| | | | last_stable_center_of_mass and cur_center_of_mass which returns a bool. If res is | | | | | |
| | | | true, then: | | | | | |
| | | | 4.1.1.1. | Set n_stable_samples to 0. | | | | |
| | | | 4.1.1.2. | Set the state to CHANGING. | | | | |
| | 4.2. | Else (the tile's state is not STABLE): | | | | | | |
| | | 4.2.1. | See if the tile is now stable. Set res to the inverse of the result of calling the | | | | | |
| | | | function significant_change( ) with the parameters prev_center_of_mass and | | | | | |
| | | | cur_center_of_mass. | | | | | |
| | | 4.2.2. | Read res. | | | | | |
| | | | 4.2.2.1. | If res is true, then: | | | | |
| | | | | 4.2.2.1.1. | Set the state to STABILIZING. | | | |
| | | | | 4.2.2.1.2. | Increment n_stable_samples by 1. | | | |
| | | | | 4.2.2.1.3. | If n_stable_samples is greater than n_samples_stability_window, | | | |
| | | | | | then: | | | |
| | | | | | 4.2.2.1.3.1. | See if the center of mass has significantly changed overall. | | |
| | | | | | Set res2 to the result of calling the function significant_change( ) | | | |
| | | | | | with the parameters last_stable_center_of_mass and | | | |
| | | | | | cur_center_of_mass. | | | |
| | | | | | 4.2.2.1.3.2. | Read res2. | | |
| | | | | | | 4.2.2.1.3.2.1. | If res2 is true, then: | |
| | | | | | | | 4.2.2.1.3.2.1.1. | Set last_stable_center_of_mass to |
| | | | | | | | | cur_center_of_mass. |
| | | | | | | | 4.2.2.1.3.2.1.2. | Set the state to STABLE_WITH_NEW_CONTENT. |
| | | | | | | 4.2.2.1.3.2.2. | Else (res2 is false): | |
| | | | | | | | 4.2.2.1.3.2.2.1. | Set the state to STABLE |

| 4.2.2.2. | Else (res is false): | |
|---|---|---|
| | 4.2.2.2.1. | Set n_stable samples to 0. |
| | 4.2.2.2.2. | Set the state to CHANGING. |

| | |
|---|---|
| 5. | Set prev_center of mass to cur_center_of_mass. |
| 6. | Return the state. |

The function significant_change(center_of_mass1, center_of_mass2) can be expanded, for example, as detailed in TABLE 4.

TABLE 4

| | |
|---|---|
| 1. | Identify the Euclidean distance d between center_of_ |
| | mass1 and center_of_mass2. |
| 2. | Return whether or not d is greater than a predetermined |
| | threshold distance (e.g., 3). |

The function IdentifyForeground(img, msk_adaptive, msk_canny) can be expanded, for example, as detailed in TABLE 5.

TABLE 5

| 1. | Compute the average pixel value of all outermost border pixels in img, excluding any | | | | |
|---|---|---|---|---|---|
| | corresponding foreground pixels identified (i.e., “on”) in msk_adaptive. Store the result in | | | | |
| | avg. | | | | |
| 2. | Set bkgrnd to the result of a bitwise-or operation between msk_adaptive and msk_canny. | | | | |
| | Combining both masks together increases the odds of finding complete edges of foreground | | | | |
| | objects. However, in practice it has been observed that canny edge detection finds the | | | | |
| | outside border of objects, which are technically not foreground, so the effect of the canny | | | | |
| | mask will be removed at a later step. | | | | |
| 3. | Repeat for every outermost border pixel p in img: | | | | |
| | 3.1. | If p is not currently marked in bkgrnd and the value of p is greater than or equal | | | |
| | | to avg in all color channels, then: | | | |
| | | 3.1.1. | Initiate a flood fill from p on bkgrnd setting all flood-filled pixels to a | | |
| | | | value of 127. | | |
| 4. | Set the pixels of bkgrnd to 0 in all cases where the pixels of bkgrnd are not equal to 127. | | | | |
| 5. | Set the pixels of bkgrnd to 255 in all cases where the pixels of bkgrnd are equal to 127. | | | | |
| 6. | At this point, all “on” pixels in bkgrnd should correspond to background on the whiteboard, | | | | |
| | but not all background on the whiteboard are necessarily identified as “on” pixels in bkgrnd. | | | | |
| | Hence, every potential foreground object has to be investigated for holes. Any pixels | | | | |
| | identified in msk_adaptive are assumed to be foreground (i.e., not a hole), but as noted in | | | | |
| | step 2 above, any pixels in msk_canny will also require a closer investigation to determine | | | | |
| | if they are truly foreground. Hence, set holes to the result of a bitwise-and operation | | | | |
| | between 255-bkgrnd and 255-msk_adaptive. All “on” pixels in holes will require a more | | | | |
| | detailed investigation to determine whether or not it really is background. | | | | |
| 7. | Identify all connected components cc (e.g., using OpenCV's connectedComponents) | | | | |
| | in holes. This identifies all groupings of connected pixels in holes or in other words | | | | |
| | identifies each individual potential hole. | | | | |
| 8. | Repeat for each connected component c (i.e., hole) in cc (i.e., set of all holes): | | | | |
| | 8.1. | Find the bounding box bbox of c as well as the average pixel value hole_avg of all | | | |
| | | corresponding pixels in img of c. Also identify the number of pixels in c as | | | |
| | | num_hole_pixels. | | | |
| | 8.2. | Starting in the center of bbox, expand the perimeter from the center outwards in | | | |
| | | growing rectangles identifying the set of all neighboring background pixels in | | | |
| | | bkgrnd until the count of neighboring background pixels meets or exceeds num_ | | | |
| | | hole_pixels. Determine the average pixel value of corresponding pixels of the | | | |
| | | set of neighboring background pixels in img as neighboring_avg. | | | |
| | 8.3. | Determine if, on average, the hole qualifies as background. This is done by | | | |
| | | comparing the difference d between hole avg and neighboring_avg per color | | | |
| | | channel. Determine if d in any color channel exceeds a predetermined threshold. | | | |
| | 8.4. | If d exceeds a predetermined threshold, then: | | | |
| | | 8.4.1. | The hole overall is not background, but some pixels may be. Repeat for every | | |
| | | | pixel in c: | | |
| | | | 8.4.1.1. | Compare the difference between the pixel and neighboring_avg | |
| | | | | per color channel. If the difference in all color channels is less | |
| | | | | than or equal to a predetermined threshold, then: | |
| | | | | 8.4.1.1.1. | Set bkgrnd at the corresponding pixel to “on” (e.g., 255). |

| 8.5. | Else (d does not exceed a predetermined threshold): | |
|---|---|---|
| | 8.5.1. | Set bkgrnd to the result of a bitwise-or operation between bkgrnd and c. |

| | |
|---|---|
| 9. | Return foreground as the inverse of bkgrnd. |

FIGS. 3A-3O show an implementation example in accordance with one or more embodiments of the invention. The implementation example shown in FIGS. 3A-3O is based on the system and method flowchart described in reference to FIGS. 1-2 and the algorithms listed in TABLES 1-5 above. In one or more embodiments of the invention, one or more elements shown in FIGS. 3A-3O may be omitted, repeated, and/or organized in a different arrangement. Accordingly, the scope of the invention should not be limited to the specific arrangement of elements shown in FIGS. 3A-3O.

In the example of FIGS. 3A-3O described below, static written content on a whiteboard and/or one or more objects placed on the whiteboard are extracted and automatically shared with other participants (i.e., collaborating users) in a collaboration session. In a conventional process, when a user has content that was ready to be shared with remote participants (i.e., collaborating users), the user would manually initiate a capture of the content and send the captured content to remote participants in the collaboration session. The conventional process was cumbersome and prevented remote participants from getting content in near real time. In contrast, the example method described below advantageously provides an improvement of automatic capturing of a user's whiteboard content (i.e., static user content) for real-time sharing with remote collaborators.

The example method of one or more embodiments operates on a series of images from a video stream. The video stream may be a pre-recorded collaboration session or a live stream of a current collaboration session. Before the first image in the video stream is processed, initialization is performed as detailed in TABLE 1 above. The process described below is then repeated for each image of the video stream.

Each frame in the video stream is broken up into tiles and analyzed for new static user content using a quick estimate of foreground content. In practice, the estimate generally identifies just the outline of any objects placed on the whiteboard. Once new static user content has been identified in any tile based on the estimate, a more rigorous process is initiated to identify the full foreground content, including the interiors of any objects. Accordingly, an update of static user content present in any tile is shared with remote participants in the collaboration session based on the full foreground identification and an average of previous stable samples. Identifying the new static user content using the quick estimate of foreground content advantageously reduces the computing resources and image processing time. Generating the updated static user content using the more rigorous process further advantageously allows both thin text strokes as well as patterns with solid fill (e.g., a physical object, user drawn solid figures) to be shared as the user static content sent to the remote participants in the collaboration session.

Further, automatically transmitting new static user content when detected advantageously eliminates a user's manual initiation of the capture and sending of the content to remote participants in the collaboration session. Such transmission of a tile's static user content based on determining when new content is available and stable also advantageously minimizes (i.e., reduces) the number of necessary content data transmissions to remote participants in the collaboration session. Furthermore, during the content data transmission, the tiles without new static user content are excluded from the transmission. Excluding the tiles with no new user static content advantageously minimizes (i.e., reduces) the amount of content data in each of the content data transmission to remote participants in the collaboration session. Furthermore, automatically transmitting the new static user content will also advantageously allow content to be seen by remote participants sooner than had the user manually initiated the capture.

The process will now be discussed in more detail. Steps 1-4 in the main algorithm in TABLE 2 above are initial preparation tasks. These initial steps are used to prepare data samples for subsequent analysis. Each set of consecutive n (e.g., n=2 in an example implementation) frames in the video stream are averaged to generate an averaged sample that minimizes the effects of motion and maximizes the effects of static user content. Any user content on the whiteboard identified as pixels in each image of the set show up strongly (i.e., exhibit higher numerical values) in the averaged sample. In contrast, any user motion is likely identified as disparate pixels in different images and consequently does not show up strongly (i.e., exhibit lower numerical values) in the averaged sample. For example, consider the two averaged samples (301a) and (301b) shown in FIG. 3A. The averaged sample (301a) corresponds to a tile in the result of averaging a first set of 2 images, and the averaged sample (301b) corresponds to a tile in the result of averaging the next set of 2 images. A faint blur (323a) exists in the averaged sample (301a) as a result of the user's hand captured in some of the first set of 2 images. Regardless, the static user content (311a) is not obscured in the averaged sample (301a) and matches the static user content seen in the averaged sample (301b). For example, the static user content (311a) may correspond to a fraction of the user's writing (e.g., $110) that falls within the particular tile. Specifically, each of the four separate elements in the static user content (311a) corresponds to a fraction of one of the four symbols $, 1, 1, and 0 written by the user.

Throughout the discussion below, the averaged sample described above is referred to as a sample. In addition to the aforementioned averaging, a log of recently generated data, recent_records, is checked to see if it exceeds the size of the stability window, which is the number of samples that must be deemed stable for an update to occur. If the size of the stability window is exceeded, then the oldest entry is removed before a new one is started. The data recorded in this log is detailed in TABLE 1 above but in general it is all of the data required over the stability window to generate a full foreground and provide an update of stable content.

All subsequent processing happens on a sample by sample basis. That sample-by-sample processing occurs in the sub-steps of step 5 in the main algorithm in TABLE 2 above. In particular, estimated foreground content is identified in each sample by running an adaptive thresholding function on each color channel of the sample and using a bitwise-OR function to combine all color channels together into a single binary image that corresponds to msk_adaptive listed in TABLE 2 above. As shown in FIG. 3A, the binarized sample (302a) and the binarized sample (302b) are both examples of a tile portion of the binary image. Furthermore, some post processing steps are executed to generate the binarized samples (302a) and (302b) for improving the quality of the estimated foreground identification in the binary image, such as healing holes (i.e., remedying holes in the image in faint portions of the pen stroke) and slightly expanding the foreground area (to compensate in imaging artifacts from one averaged sample to another). Identifying the estimated foreground content in the two averaged samples (301a) and (301b) results in the corresponding binarized samples (302a) and (302b). The white pixels in each of the binarized samples (302a) and (302b) correspond to the identified estimated foreground in the corresponding sample.

Continuing with the sample-by-sample processing, the next step is to identify the center of mass (COM) in each binarized sample. The COM is computed as the average location of all estimated foreground (white) pixels in the binarized sample. The COM is assigned an “undefined” status when the total number of estimated foreground (white) pixels in the binarized sample is less than a pre-determined threshold (e.g., 10). The COM is used for motion tracking and stability identification. For the two binarized samples (302a) and (302b), the COM is identified by the icon “x” to generate the marked samples (303a) and (303b). The averaged sample (301a) and the binarized sample (302a) correspond to the marked sample (303a) with the COM (313a), the averaged sample (301b) and the binarized sample (302b) correspond to the marked sample (303b) with the COM (313b). A slight shift exists between the COM (313a) and the COM (313b) as result of a noise pattern (312b) being identified as additional foreground from the binarized sample (302a) to the binarized sample (302b).

FIGS. 3B-3E illustrate an example (referred to as “EXAMPLE 1”) sequence of samples (i.e., sample 0 through sample 6) with associated data records. Each sample in the sequence is divided into 6 rows (i.e., row 0 through row 5) and 8 columns (i.e., column 0 through column 7) resulting in 48 tiles. The data records associated with 6 of the 48 tiles are also shown with the corresponding sample.

FIG. 3B shows sample 0 organized in 4 horizontal sections. The first horizontal section is labeled “Averaged Frames” where the gray rectangle represents the averaged sample of a set of consecutive n (e.g., n=2) images in the video stream. The gray rectangle is overlaid with the tile grid (320) that divides sample 0 into 48 tiles. For example, tile (1,2) (312) is the tile in row 1 and column 2, tile (1,3) (313) is the tile in row 1 and column 3, tile (2,2) (322) is the tile in row 2 and column 2, tile (2,3) (323) is the tile in row 2 and column 3, tile (3,2) (332) is the tile in row 3 and column 2, and tile (3,3) (333) is the tile in row 3 and column 3. The second, third, and fourth horizontal sections of sample 0 show data records associated with these 6 tiles and are labeled “Tile,” “Fgd Est,” and “State,” respectively. Consistent with sub-steps of Step 4 in TABLE 1 above, data record (330) includes the row number, column number, binarized image, and current state of the tile (1,2) (312). Specifically, the binarized image (312a) represents the estimated foreground content of the tile (1,2) (312) and corresponds to the variable msk_adaptive listed in TABLE 2 and TABLE 5 above. In the following discussions, the estimated foreground content is also referred to as the foreground estimate or “Fgd Est.” The data records of the remaining tiles in the second, third, and fourth horizontal sections of sample 0 are organized similarly to the data record (330). Based on these data records of sample 0, there is no activity on the whiteboard. The remaining sample 1 through sample 6 are shown in FIGS. 3C-3E according to the same format as sample 0 described in reference to FIG. 3B. The tile grid (320) is omitted in sample 1 through sample 6 for clarity.

In samples 1 and 2 shown in FIG. 3C, the user's hand enters the scene to place an apple on the whiteboard. In samples 3-6 shown in FIGS. 3D-3E, the apple is left untouched on the whiteboard. Throughout FIGS. 3C-3E, the COM of each tile, when available, is shown as a white dot in the corresponding binarized image. In addition, the gray pixels represent “1” or “ON” in the binarized image of each tile and correspond to the estimated foreground content detected in the corresponding tile. For example, in sample 1 depicted in FIG. 3C, the COM (330) is shown in the binarized image associated with tile (2,3), and the gray pixels (e.g., pixels (331)) in the binarized image correspond to detected edges of a dimple in the apple and the user's hand. Due to the motion of the user's hand holding the apple, the COM and detected edges in the binarized image for the tile (2,3) change in sample 2 in comparison to sample 1.

For sample 0 through sample 6, as detailed in step 5.3 of the main algorithm in TABLE 2 above, the averaged frames image is scaled down. This is primarily done as a performance optimization. Then, the foreground estimate for each scaled down average is computed as detailed in step 5.4 using adaptive thresholding. In step 5.5 above, the foreground estimate is divided into tiles and each tile is monitored for changes and stability. In EXAMPLE 1 above, some of the foreground estimate pieces are illustrated (seen as “Fgd Est”) for the 6 tiles immediately encompassing the apple.

In sample 3 depicted in FIG. 3D, tile (1,2) is in the process of stabilizing while the remaining tiles are still changing. In sample 4, tile (1,2) has completely stabilized with new content (in this example the stability window is 2 samples) whereas the remaining tiles begin to enter the stabilizing phase. As detailed in step 5.6 of the main algorithm in TABLE 2 above, the full foreground content is detected in response to tile (1,2) entering the state STABLE_WITH_NEW_CONTENT and the portion of the apple that corresponds to tile (1,2) is sent to remote participants. A similar process occurs in sample 5 depicted in FIG. 3E where the remaining tiles (1,3), (2,2), (2,3), (3,2), and (3,3) become STABLE_WITH_NEW_CONTENT. Finally, in sample 6, all tiles remain in a STABLE state and no new updates are sent.

FIGS. 3F-3J illustrate another example (referred to as “EXAMPLE 2”) sequence of samples (i.e., sample 0 through sample 18) with associated data records of a particular tile (i.e., tile (2,4)). Specifically, EXAMPLE 2 illustrates the tile monitoring process listed in TABLES 3 and 4 above. The associated data records represent the state of tile monitoring at the end of executing the steps of TABLES 3 and 4 above for each sample.

Similar to the EXAMPLE 1 above, each sample in the sequence of EXAMPLE 2 is divided into 6 rows (i.e., row 0 through row 5) and 8 columns (i.e., column 0 through column 7) resulting in 48 tiles. The tile grid dividing each sample is omitted for clarity.

FIG. 3F shows sample 0 through sample 2 of the EXAMPLE 2 where each row corresponds to one sample and is organized in 6 vertical sections. The first vertical section is labeled “Sample Num” that identifies the sample number of each row of samples. The second vertical section is labeled “Averaged Frames” where the gray rectangle represents the averaged sample of a set of consecutive n (e.g., n=2) images in the video stream. The rectangular box in each averaged sample represents tile (2,4) in row 2 and column 4 of the 48 tiles. For example, tile (2,4) is explicitly identified as tile (2,4) (324) for sample 0. The third, fourth, fifth, and sixth vertical sections of sample 0 show data records associated with tile (2,4) and are labeled “Tile Fgd Est,” “Tile State,” “Tile COMs,” and “Num Stable Samples,” respectively. In particular, the labels “Tile Fgd Est” and “Tile State” correspond to “Fgd Est” and “State” depicted in FIGS. 3B-3E above. Consistent with sub-steps of step 4 in TABLE 1 above, the data record (340) associated with tile (2,4) (324) for sample 0 includes the binarized image, current state, and several versions of the COM of tile (2,4) (324). Specifically, the binarized image (324a) represents the estimated foreground content of tile (2,4) (324), and the state is initialized as STABLE.

In the EXAMPLE 2, no foreground content is detected in sample 0. With sample 1, the user's hand enters the scene and provides enough contrast to register an edge on the foreground estimate. In step 3 of TABLE 3, the COM of all foreground pixels in the estimate is computed as the average location of all foreground content. In step 4, a determination is made based on whether the tile's state is currently STABLE. If so, then the tile monitor determines whether or not the tile is no longer STABLE (branch 4.1). Otherwise, the tile monitor determines whether the tile has now become stable (branch 4.2). At the start of monitoring for sample 1, the tile is STABLE and is checked to see whether the newly computed current COM (36.9, 40.3) has significantly changed from the last stable COM (undefined). This is registered as a significant change and so the state is updated to CHANGING for sample 1.

With sample 2, the new current COM is computed (22.7, 34.3). Now, since the state is currently CHANGING, branch 4.2 is processed to determine if the tile has now stabilized. It is determined if there is not a significant change from the previous COM (36.9, 40.3) to the current COM. In this case, there is a significant change and therefore branch 4.2.2.2 is executed and the tile remains in a CHANGING state for sample 2.

FIG. 3G shows sample 3 through sample 6 of the EXAMPLE 2 where each row is organized in the same manner as FIG. 3F. With sample 3, the users hand leaves the scene and there is no longer any identified foreground content in the tile. The COM has changed from (22.7, 34.3) to undefined, and so as with sample 2, the tile remains in a CHANGING state.

With sample 4, the algorithm again processes branch 4.2 but now the COM does not significantly change (undefined to undefined) and so branch 4.2.2.1 is executed. Here, the state changes to STABILIZING and the number of stable samples is incremented to 1. In step 4.2.2.1.3, it is determined that the number of stable samples has not reached the stability window (e.g., 2 samples) and so processing for this sample ends.

The same processing happens with sample 5 as with sample 4, but this time the stability window (e.g., 2 samples) has been reached and so branch 4.2.2.1.3.1 is executed. In this case, it is determined if the change qualifies for an update. In other words, it is determined if the last stable COM (undefined) has significantly changed to the current COM (undefined). In this case, it has not, and therefore the tile becomes STABLE, but there is no new content to share.

Processing continues in this manner, as depicted in FIGS. 3G-3I, until when sample 15 through sample 18 are processed, as depicted in FIG. 3J. In sample 15, tile (2,4) has finished stabilizing and now the last stable COM (undefined) has changed to the current COM (80.5, 21.9). Thus the state changes to STABLE_WITH_NEW_CONTENT and the last stable COM is updated to the current COM for this sample. Thus, the tile monitor indicates that new stable content is ready to be shared among collaborators. Similar to sample 0, tile (2,4) is explicitly identified as tile (2,4) (324) for sample 15. Sample 16 through sample 18 illustrate the scenario where changes in the COM, possibly caused by the shadow of user's hand or a lighting change in the environment, do not result in any new stable content to be shared.

FIGS. 3K-3M show the full foreground detection process triggered by the detection of new static content, e.g., for the tile (2,4) at sample 15 in EXAMPLE 2 above. The full foreground detection process corresponds to step 5.6.1 in TABLE 2 that calls the function IdentifyForeground(img, msk_adaptive, msk_canny) listed in TABLE 5. Steps 5.6.1.1-5.6.1.7 in TABLE 2 are mostly initialization work for the process in TABLE 5. Once the tile (2,4) is identified as STABLE_WITH_NEW_CONTENT in sample 15, the image data in recent_records are averaged together across the stability window (e.g., 2 samples or sample 14 and sample 15). Foreground processing happens on these averages to send an averaged update of content across the stability window to remote participants. As shown in FIG. 3K, the downscaled samples are averaged across the stability window (i.e., samples 14 and 15) to generate the down sampled image average (351), and adaptive threshold masks are averaged across the stability window (i.e., samples 14 and 15) to generate the adaptive threshold average (352). In particular, the adaptive threshold average (352) corresponds to the estimated foreground content generated from the Fgd Est of all tiles in sample 14 and sample 15 in EXAMPLE 2. Furthermore, any missing canny edge masks in recent_records are generated and averaged together as detailed in steps 5.6.1.4, 5.6.1.5, and 5.6.1.7 to generate the canny edge average (353). The function IdentifyForeground( ) is then called with the input of the down sampled image average (351), adaptive threshold average (352), and canny edge average (353) that correspond to the variables img, msk_adaptive, and msk_canny listed in TABLE 5 above.

The first step in TABLE 5 is to compute the average pixel value of all the border pixels in img, excluding those that are identified as foreground in msk_adaptive. This is done to identify suitable places to launch a flood fill in a subsequent step.

In step 2 of TABLE 5, bkgrnd is initially set to the result of a bitwise-or operation between msk_adaptive and msk_canny. This results in the mask (361) shown in FIG. 3L. Combining msk_adaptive and msk_canny increases the possibility of generating contiguous edges for a subsequent flood fill step. However, it has been observed in practice that the canny edge mask identifies the outside border of pixels, which may not be foreground, and so the effect of the canny edge mask will be removed at a later point.

In step 3 of TABLE 5, a flood fill of bkgrnd is initiated from the border pixels but only if the pixel is not already marked (i.e., “1” or “ON”) in bkgrnd and if the corresponding pixel in img is greater than the average border pixel previously computed. This second condition helps ensure that flood filling occurs from the brightest portions which are likely to be whiteboard background (and not, for example, from the users hand and/or arm). In this case, a single flood fill is launched from border pixel (94, 0) setting flooded pixels to color value 127 (i.e., gray) resulting in the flooded image (362). In TABLE 5, bkgrnd is an 8-bit deep mask with pixel values of 0 to 255 as an interim step to generate a true binary mask where all pixels are strictly ON or OFF by the end of step 5 in TABLE 5.

In step 4 of TABLE 5, the pixels of bkgrnd are set to 0 in all cases where the pixels are not equal to 127. These pixels are known to NOT be background. Then, in step 5 of TABLE 5, the pixels of bkgrnd are set to 255 in all cases where the pixels are equal to 127. These are the flood filled pixels and are assumed to be background. At this point, bkgrnd looks like the mask (363) as an example of the content of the variable bkgrnd at the end of step 5 of TABLE 5, which is referred to as “starting background” depicted in FIG. 3M below.

In bkgrnd, all ON (white) pixels shown in the mask (363) (i.e., starting background) are considered as known background. However, not all background pixels in the sample are necessarily shown as ON (white) in the mask (363). In other words, some OFF (black) pixels in the mask (363) may also be background and correspond to an interior hole of a foreground object in the sample. Hence, every potential foreground object has to be investigated for holes. Any pixels identified in msk_adaptive (i.e., estimated foreground content) are assumed to be foreground (i.e., not a hole), but as noted in step 2 above, any pixels in msk_canny will also require a closer investigation to determine if they are truly foreground. Hence, in step 6 of TABLE 5, holes is set to the result of a bitwise-and operation between 255—bkgrnd (i.e., inverted starting background) and 255—msk_adaptive (i.e., inverted estimated foreground content), which is shown as the candidate holes mask (364).

All “ON” pixels in candidate holes mask (364) will require a more detailed investigation to determine whether or not it really is background.

In step 7 of TABLE 5, all connected components are identified in a candidate holes mask (364). In this case, 105 individual connected components are identified.

In step 8 of TABLE 5, iterative hole traversal and background mending is performed on the starting background. Each connected component in candidate holes mask (364) is processed to determine if it qualifies as foreground or background by comparing the corresponding pixel intensities of the connected component in img (351) to the average pixel intensity of neighboring pixels. The neighboring pixels are accumulated as the closest neighboring pixels of known background with a count approximately equal to the number of pixels in the connected component. Pixels in the connected component are first compared based on the average value of corresponding pixels in src followed by individual pixel comparisons. The content of bkgrnd at the end of step 8 of TABLE 5 is referred to as “updated background” depicted in FIG. 3M below. In other words, the updated background is the result of performing iterative hole traversal and background mending on the starting background.

FIG. 3M shows example iterations of the hole traversal and background mending process of step 8 in TABLE 5. In FIG. 3M, each row corresponds to one iteration of the hole traversal and background mending process. In particular, the final updated background (371) generated in the final iteration (370) is inverted in step 9 of TABLE 5 and returned by the function IdentifyForeground(img, msk_adaptive, msk_canny) to step 5.6.1.8 of TABLE 2 as a mask of the full foreground content, which is shown as the full foreground mask (380) in FIG. 3N. In step 5.6.1.9 and step 5.6.2 of TABLE 2, any down scaling is undone and update_fg is updated with the portion of the full foreground mask (380) that corresponds to the tile area. Furthermore, update_img is updated with the portion of the averaged original sample that corresponds to the tile area bitwise-anded with the tile's portion of the full foreground mask. The update_fg and update_img updating process is repeated for all tiles in the tile grid that have states STABLE or STABLE_WITH_NEW_CONTENT.

FIG. 3O shows a tile portion (381) of the user static content update_img corresponding to the tile (2,4) (324) in sample 15 depicted in 3J above. The gray foreground pixels in the tile portion (381) are assigned corresponding pixel values in sample 15. In one or more embodiments, the tile portion (381) of the user static content is shared with collaborating users as soon as detecting the tile (2,4) as stable with new content. The tile portion (381) of the user static content may be shared with collaborating users individually or collectively with other tile(s) detected as stable with new content. Alternatively, the static user content may be aggregated over all tiles and shared with collaborating users as an entire sample with new content. While detecting the stabilized change of COM for each tile and generating the mask of the full foreground content may be performed based on the down scaled sample with reduced pixel resolution to improve computing efficiency (i.e., reducing computing time and other resources), the user static content is shared with collaborating users at the original scale with original pixel resolution.

Embodiments of the invention may be implemented on virtually any type of computing system, regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments of the invention. For example, as shown in FIG. 4, the computing system (400) may include one or more computer processor(s) (402), associated memory (404) (e.g., random access memory (RAM), cache memory, flash memory, etc.), one or more storage device(s) (406) (e.g., a hard disk, an optical drive such as a compact disk (CD) drive or digital versatile disk (DVD) drive, a flash memory stick, etc.), and numerous other elements and functionalities. The computer processor(s) (402) may be an integrated circuit for processing instructions. For example, the computer processor(s) may be one or more cores, or micro-cores of a processor. The computing system (400) may also include one or more input device(s) (410), such as a touchscreen, keyboard, mouse, microphone, touchpad, electronic pen, or any other type of input device. Further, the computing system (400) may include one or more output device(s) (408), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (400) may be connected to a network (412) (e.g., a local area network (LAN), a wide area network (WAN) such as the Internet, mobile network, or any other type of network) via a network interface connection (not shown). The input and output device(s) may be locally or remotely (e.g., via the network (412)) connected to the computer processor(s) (402), memory (404), and storage device(s) (406). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

Further, one or more elements of the aforementioned computing system (400) may be located at a remote location and be connected to the other elements over a network (412). Further, one or more embodiments of the invention may be implemented on a distributed system having a plurality of nodes, where each portion of the invention may be located on a different node within the distributed system. In one or more embodiments, the node corresponds to a distinct computing device. Alternatively, the node may correspond to a computer processor with associated physical memory. The node may alternatively correspond to a computer processor or micro-core of a computer processor with shared memory and/or resources.

One or more embodiments of the present invention provide the following improvements in electronic collaboration technologies: automatically sharing user content on a marker board with remote collaborating users without the user having to manually send the content data; limiting the amount of content data transmission to the portion of the marker board with new content; minimizing the number of content data transmissions by automatically determining when the new content is stable prior to transmission; improving performance in detecting new static user content by down scaling the image sample and using simplified foreground content estimation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method to extract static user content on a marker board, the method comprising:
generating a sequence of samples from a video stream comprising a series of images of the marker board;
generating at least one center of mass (COM) of estimated foreground content of each sample in the sequence of samples;
detecting, based on a predetermined criterion, a stabilized change of the at least one COM in the sequence of samples, wherein the stabilized change of the at least one COM identifies, in the sequence of samples, a stable sample with new content;
generating, in response to the stabilized change of the at least one COM and from the stable sample with new content, a mask of full foreground content; and
extracting, based at least on the mask of full foreground content, a portion of the static user content from the video stream.

2. The method of claim 1, wherein generating the sequence of samples comprises:
dividing the series of images into a plurality of consecutive portions; and
generating said each sample by at least averaging a corresponding consecutive portion of the plurality of consecutive portions.

3. The method of claim 1, wherein generating the at least one COM of the estimated foreground content comprises:
applying an adaptive thresholding algorithm to said each sample to generate an adaptive mask, wherein the estimated foreground content comprises the adaptive mask;
dividing said each sample into a plurality of tiles; and
generating a COM of a tile of the plurality of tiles based on the adaptive mask,
wherein the at least one COM of the estimated foreground content comprises the COM of the tile, and
wherein detecting the stabilized change of the at least one COM comprises monitoring an amount of change of the COM of the tile over a stability window.

4. The method of claim 3, wherein generating the mask of the full foreground comprises:
generating, by at least applying a flood fill algorithm to the estimated foreground content, a starting background;
generating, by at least applying a bitwise-and operation to an inversion of the starting background and an invresion of the estimated foreground content, a candidate holes mask;
iteratively adjusting, based on one or more connected components in the candidate holes mask, the starting background to generate an ending background; and
inverting the ending background to generate the mask of the full foreground content.

5. The method of claim 4, wherein generating the full foreground further comprises:
identifying connected component pixels in said each sample that correspond to the one or more connected component in the candidate holes mask; and
comparing pixel intensities of the connected component pixels to an average pixel intensity of neighboring pixels of the connected component pixels to generate a comparison result,
wherein iteratively excluding the one or more connected component from the starting background is based at least on the comparison result.

6. The method of claim 3, further comprising:
generating the static user content by aggregating the portion of the static user content over the plurality of tiles; and
sending the static user content to a collaborating user.

7. The method of claim 1,
wherein the video stream is a live video stream of a collaboration session, and
wherein the static user content is sent to a collaborating user in real-time with respect to the live video stream.

8. A system for extracting static user content on a marker board, the system comprising:
a memory; and
a computer processor connected to the memory and that:
generates a sequence of samples from a video stream comprising a series of images of the marker board;
generates at least one center of mass (COM) of estimated foreground content of each sample in the sequence of samples;
detects, based on a predetermined criterion, a stabilized change of the at least one COM in the sequence of samples, wherein the stabilized change of the at least one COM identifies in the sequence of samples a stable sample with new content;
generates, in response to the stabilized change of the at least one COM and from the stable sample with new content, a mask of full foreground content; and
extracts, based at least on the mask of full foreground content, a portion of the static user content from the video stream.

9. The system of claim 8, wherein generating the sequence of samples comprises:
dividing the series of images into a plurality of consecutive portions; and
generating said each sample by at least averaging a corresponding consecutive portion of the plurality of consecutive portions.

10. The system of claim 8, wherein generating the at least one COM of the estimated foreground content comprises:
applying an adaptive thresholding algorithm to said each sample to generate an adaptive mask, wherein the estimated foreground content comprises the adaptive mask;
dividing said each sample into a plurality of tiles; and
generating a COM of a tile of the plurality of tiles based on the adaptive mask,
wherein the at least one COM of the estimated foreground content comprises the COM of the tile, and
wherein detecting the stabilized change of the at least one COM comprises monitoring an amount of change of the COM of the tile over a stability window.

11. The system of claim 10, wherein generating the mask of the full foreground comprises:
generating, by at least applying a flood fill algorithm to the estimated foreground content, a starting background;
generating, by at least applying a bitwise-and operation to an inversion of the starting background and an inversion of the estimated foreground content, a candidate holes mask;
iteratively adjusting, based on one or more connected components in the candidate holes mask, the starting background to generate an ending background; and
inverting the ending background to generate the mask of the full foreground content.

12. The system of claim 11, wherein generating the full foreground further comprises:
identifying connected component pixels in said each sample that correspond to the one or more connected component in the candidate holes mask; and
comparing pixel intensities of the connected component pixels to an average pixel intensity of neighboring pixels of the connected component pixels to generate a comparison result,
wherein iteratively excluding the one or more connected component from the starting background is based at least on the comparison result.

13. The system of claim 10, where the computer processor further:
generates the static user content by aggregating the portion of the static user content over the plurality of tiles; and
sends the static user content to a collaborating user.

14. The system of claim 8,
wherein the video stream is a live video stream of a collaboration session, and
wherein the static user content is sent to a collaborating user in real-time with respect to the live video stream.

15. A non-transitory computer readable medium (CRM) storing instructions for extracting static user content on a marker board, wherein the computer readable program code, when executed by a computer, comprises functionality for:
generating a sequence of samples from a video stream comprising a series of images of the marker board;
generating at least one center of mass (COM) of estimated foreground content of each sample in the sequence of samples;
detecting, based on a predetermined criterion, a stabilized change of the at least one COM in the sequence of samples, wherein the stabilized change of the at least one COM identifies in the sequence of samples a stable sample with new content;
generating, in response to the stabilized change of the at least one COM and from the stable sample with new content, a mask of full foreground content; and
extracting, based at least on the mask of full foreground content, a portion of the static user content from the video stream.

16. The non-transitory CRM of claim 15, wherein generating the sequence of samples comprises:
dividing the series of images into a plurality of consecutive portions; and
generating said each sample by at least averaging a corresponding consecutive portion of the plurality of consecutive portions.

17. The non-transitory CRM of claim 15, wherein generating the at least one COM of the estimated foreground content comprises:
applying an adaptive thresholding algorithm to said each sample to generate an adaptive mask, wherein the estimated foreground content comprises the adaptive mask;
dividing said each sample into a plurality of tiles; and
generating a COM of a tile of the plurality of tiles based on the adaptive mask,
wherein the at least one COM of the estimated foreground content comprises the COM of the tile, and
wherein detecting the stabilized change of the at least one COM comprises monitoring an amount of change of the COM of the tile over a stability window.

18. The non-transitory CRM of claim 17, wherein generating the mask of the full foreground comprises:
generating, by at least applying a flood fill algorithm to the estimated foreground content, a starting background;
generating, by at least applying a bitwise-and operation to an inversion of the starting background and an inversion of the estimated foreground content, a candidate holes mask;
iteratively adjusting, based on one or more connected components in the candidate holes mask, the starting background to generate an ending background; and
inverting the ending background to generate the mask of the full foreground content.

19. The non-transitory CRM of claim 18, wherein generating the full foreground further comprises:
identifying connected component pixels in said each sample that correspond to the one or more connected component in the candidate holes mask; and
comparing pixel intensities of the connected component pixels to an average pixel intensity of neighboring pixels of the connected component pixels to generate a comparison result,
wherein iteratively excluding the one or more connected component from the starting background is based at least on the comparison result.

20. The non-transitory CRM of claim 17, the computer readable program code, when executed by the computer, further comprising functionality for:
generating the static user content by aggregating the portion of the static user content over the plurality of tiles; and
sending the static user content to a collaborating user,
wherein the video stream is a live video stream of a collaboration session, and
wherein the static user content is sent to a collaborating user in real-time with respect to the live video stream.
